(19) United States
(12) Patent Application Publication
(10) Pub. No.: US 2026/0342126 A1
(43) Pub. Date: Oct. 29, 2026

(54) UNINTERRUPTIBLE POWER SUPPLY AND CONTROL METHOD THEREOF

(71) Applicant: LIAN ZHENG ELECTRONICS (SHENZHEN) CO., LTD., SHENZHEN (CN)

(72) Inventors: Heyi XU, Shenzhen (CN); Yiping WU, Shenzhen (CN); Tianfeng TAN, Shenzhen (CN)

(21) Appl. No.: 19/658,765

(22) Filed: Apr. 27, 2026

(30) Foreign Application Priority Data
Apr. 29, 2025 (CN) 202510560739.6

(51) Int. Cl. H02J 9/06; H02M 1/00; H02M 1/08; H02M 1/088; H02M 7/5387

(52) U.S. Cl. CPC H02J 9/062; H02M 1/0058; H02M 1/083; H02M 1/088; H02M 7/53875

(57) ABSTRACT

An uninterruptible power supply includes an input terminal, output terminal, a three-bridge arm circuit, and a controller. The input terminal is configured to be electrically connectable to an alternating current power supply; the output terminal is configured to be electrically connectable to a load; the three-bridge arm circuit electrically connected between the input and output terminal, configured to provide rectified and inverted outputs from the input to the output; and a controller. The controller is configured to: compare a first alternating current voltage received at the input with a second alternating current voltage output at the output; compare the first alternating current voltage with a first voltage threshold when a reverse occurs between the first alternating current voltage and the second alternating current voltage; and execute a reverse control logic on the three-bridge arm circuit when the first alternating current voltage is greater than the first voltage threshold.

### CROSS REFERENCE TO RELATED APPLICATIONS

This application claims benefit to Chinese Patent Application No. CN202510560739.6, filed on Apr. 29, 2025, which is hereby incorporated by reference herein.

### FIELD

The present disclosure relates to the field of power supplies, and in particular to an uninterruptible power supply.

### BACKGROUND

The statements in this part are merely intended to provide background information related to the present disclosure, to help understand the present disclosure. The background information does not necessarily constitute the prior art.

An uninterruptible power supply (UPS) is a voltage-stable and frequency-stable alternating current power supply that includes an energy storage apparatus (such as a battery). The UPS is mainly composed of components such as a rectifier, an inverter, and the energy storage apparatus. A core function of the UPS is to provide uninterrupted power supply for computer and communication network systems (such as computers, servers, storage devices, network devices and the like), industrial control systems, and industrial devices that require continuous operation. When an input of a utility power is normal, the UPS stabilizes the voltage of the utility power and provides stable power to a load while charging the energy storage apparatus. Once the utility power is interrupted, the UPS can quickly switch to the energy storage apparatus for power supply and continuously provide alternating current to the load, thereby ensuring that the load can still work normally during utility power interruption, and effectively avoiding data loss or equipment damage caused by power interruption.

With the continuous development of power electronics technology, circuit topologies of UPSs have undergone various evolutions, among which a three-bridge arm circuit topology with a unique structure has attracted much attention. Compared with a conventional dual bus circuit topology, the three-bridge arm circuit topology has significant advantages in terms of device quantity and cost. The conventional dual bus circuit topology usually requires more switching devices and bus capacitors, which not only increases system complexity but also raises costs. In contrast, the three-bridge arm circuit topology significantly reduces the quantity of bus capacitors and switching devices used, lowers system costs, and improves device utilization by sharing some bridge arms. Moreover, a voltage borne by a switching device on each bridge arm of the three-bridge arm circuit topology is only half of an input voltage on a direct current side, providing a significant advantage in terms of switching losses. This low switching loss characteristic not only improves system efficiency, but also enables the three-bridge arm circuit topology to operate at higher frequencies, achieving high frequency and high speed.

However, the UPS with the three-bridge arm circuit topology still has some limitations and thus needs to be improved.

### SUMMARY

In an embodiment, the present disclosure provides an uninterruptible power supply, including: an input terminal, configured to be electrically connectable to an alternating current power supply; an output terminal, configured to be electrically connectable to a load; a three-bridge arm circuit electrically connected between the input terminal and the output terminal, and configured to provide rectified and inverted outputs from the input terminal to the output terminal; and a controller. The controller is configured to: compare a first alternating current voltage received at the input terminal with a second alternating current voltage output at the output terminal; compare the first alternating current voltage with a first voltage threshold when a reverse occurs between the first alternating current voltage and the second alternating current voltage, where the reverse includes that either the first alternating current voltage is greater than zero and the second alternating current voltage is less than zero, or the first alternating current voltage is less than zero and the second alternating current voltage is greater than zero; and execute a reverse control logic on the three-bridge arm circuit when the first alternating current voltage is greater than the first voltage threshold.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic diagram of a circuit structure of an uninterruptible power supply according to an embodiment of the present disclosure;

FIG. 2 illustrates a control waveform diagram of multiple controllable switches of an uninterruptible power supply according to an embodiment of the present disclosure;

FIG. 3 illustrates a control waveform diagram of multiple controllable switches of an uninterruptible power supply according to another embodiment of the present disclosure;

FIG. 4 illustrates a waveform diagram of an input alternating current voltage and an output alternating current voltage of an uninterruptible power supply according to an embodiment of the present disclosure when an inverter just enters a zero-crossing point at an initial time of occurrence of a reverse event; and

FIG. 5 illustrates a flowchart of a control method for an uninterruptible power supply according to an embodiment of the present disclosure.

### DETAILED DESCRIPTION

Embodiments of the present disclosure overcome the disadvantages in the prior art, and provide an uninterruptible power supply and a control method thereof.

According to an aspect of embodiments of the present disclosure, an uninterruptible power supply is provided, including:
an input terminal, configured to be electrically connectable to an alternating current power supply;
an output terminal, configured to be electrically connectable to a load;
a three-bridge arm circuit electrically connected between the input terminal and the output terminal, and configured to provide rectified and inverted outputs from the input terminal to the output terminal; and
a controller, where the controller is configured to:
compare a first alternating current voltage received at the input terminal with a second alternating current voltage output at the output terminal;
compare the first alternating current voltage with a first voltage threshold when a reverse occurs between the first alternating current voltage and the second alternating current voltage, where the reverse includes that the first alternating current voltage is greater than zero and the second alternating current voltage is less than zero, or the first alternating current voltage is less than zero and the second alternating current voltage is greater than zero; and
execute a reverse control logic on the three-bridge arm circuit when the first alternating current voltage is greater than the first voltage threshold.

According to an aspect of the uninterruptible power supply of the present disclosure, the controller is further configured to:
determine a reverse starting time when the reverse occurs between the first alternating current voltage and the second alternating current voltage; and
determine whether the second alternating current voltage passes through a zero-crossing point at the reverse starting time; and if the second alternating current voltage passes through the zero-crossing point at the reverse starting time, execute the reverse control logic on the three-bridge arm circuit when the first alternating current voltage is greater than the first voltage threshold and a phase of the second alternating current voltage is greater than a first phase threshold.

According to an aspect of the uninterruptible power supply of the present disclosure, the reverse control logic is deactivated when the first alternating current voltage and the second alternating current voltage recover to be either both positive or both negative.

According to an aspect of the uninterruptible power supply of the present disclosure, the three-bridge arm circuit includes a rectifier bridge arm, a common bridge arm, and an inverter bridge arm; the rectifier bridge arm has a high-side first switching module and a low-side second switching module; the common bridge arm has a high-side third switching module and a low-side fourth switching module; and the inverter bridge arm has a high-side fifth switching module and a low-side sixth switching module.

According to an aspect of the uninterruptible power supply of the present disclosure, the reverse control logic includes:
controlling a controllable switch in the first switching module and a controllable switch in the second switching module to turn off;
meanwhile, sending a first pulse width modulation signal and a second pulse width modulation signal with a first frequency to a control terminal of a controllable switch in the third switching module and a control terminal of a controllable switch in the fourth switching module respectively, where the first pulse width modulation signal and the second pulse width modulation signal are complementary and the first frequency is greater than a frequency of the alternating current power supply; and
when the second alternating current voltage is greater than zero, controlling a controllable switch in the fifth switching module to turn on and controlling a controllable switch in the sixth switching module to turn off; when the second alternating current voltage is less than zero, controlling the controllable switch in the fifth switching module to turn off and controlling the controllable switch in the sixth switching module to turn on.

According to an aspect of the uninterruptible power supply of the present disclosure, the reverse control logic includes:
when the first alternating current voltage is greater than zero, sending a third pulse width modulation signal with a second frequency to a control terminal of the controllable switch in the first switching module, and controlling the controllable switch in the second switching module to turn off; when the first alternating current voltage is less than zero, controlling the controllable switch in the first switching module to turn off and outputting a fourth pulse width modulation signal with the second frequency to a control terminal of the controllable switch in the second switching module, where the second frequency is greater than the frequency of the alternating current power supply;
meanwhile, outputting the third pulse width modulation signal and the fourth pulse width modulation signal to the control terminal of the controllable switch in the third switching module and the control terminal of the controllable switch in the fourth switching module respectively, where the third pulse width modulation signal and the fourth pulse width modulation signal are complementary; and
when the second alternating current voltage is greater than zero, controlling the controllable switch in the fifth switching module to turn on and controlling the controllable switch in the sixth switching module to turn off; when the second alternating current voltage is less than zero, controlling the controllable switch in the fifth switching module to turn off and controlling the controllable switch in the sixth switching module to turn on.

According to an aspect of the uninterruptible power supply of the present disclosure, the alternating current power supply is utility power, and the first voltage threshold is determined based on an effective value of the first alternating current voltage.

According to an aspect of the uninterruptible power supply of the present disclosure, the first phase threshold is between 8 degrees and 10 degrees.

According to another aspect of the embodiments of the present disclosure, a control method for an uninterruptible power supply is further provided, where the uninterruptible power supply has a three-bridge arm circuit, and the method includes:
comparing a first alternating current voltage received at an input terminal of the uninterruptible power supply with a second alternating current voltage output at an output terminal of the uninterruptible power supply;
comparing the first alternating current voltage with a first voltage threshold when a reverse occurs between the first alternating current voltage and the second alternating current voltage, where the reverse includes that the first alternating current voltage is greater than zero and the second alternating current voltage is less than zero, or the first alternating current voltage is less than zero and the second alternating current voltage is greater than zero; and
executing a reverse control logic on the three-bridge arm circuit when the first alternating current voltage is greater than the first voltage threshold.

According to an aspect of the control method of the present disclosure, the control method further includes:
determining a reverse starting time when the reverse occurs between the first alternating current voltage and the second alternating current voltage; and
determining whether the second alternating current voltage passes through a zero-crossing point at the reverse starting time; and if the second alternating current voltage passes through the zero-crossing point at the reverse starting time, executing the reverse control logic on the three-bridge arm circuit when the first alternating current voltage is greater than the first voltage threshold and a phase of the second alternating current voltage is greater than a first phase threshold.

Aspects of the present disclosure provide an uninterruptible power supply and the control method thereof. By introducing a tolerance determination mechanism, the uninterruptible power supply is able to activate a response mechanism to enter reverse control only when a reverse event exceeds strictly set threshold conditions, thereby effectively avoiding excessive response to minor or instantaneous reverse events. This innovative design significantly reduces unnecessary reverse control interventions, significantly reduces switching losses and noise, and effectively extends the service life of a device. In addition, this design further significantly enhances the adaptability and reliability of the uninterruptible power supply under complex power grid conditions, and enables the uninterruptible power supply to operate stably under various harsh working conditions, providing strong guarantees for the safe and reliable operation of a power system.

To make the objectives, technical solutions, and advantages of the present disclosure clearer, the following further describes the present disclosure in detail through specific embodiments with reference to the accompanying drawings. It should be understood that the described embodiments are some of, but not all of, the embodiments of the present disclosure. All other embodiments obtained by those of ordinary skill in the art based on the embodiments of the present disclosure without creative efforts shall fall within the protection scope of the present disclosure.

In addition, the described features, structures, or characteristics may be incorporated in one or more embodiments in any suitable manner. In the following description, many specific details are provided to give a sufficient understanding of the embodiments of the present disclosure. However, those skilled in the art would appreciate that the technical solutions of the present disclosure may be practiced without one or more specific details, or other methods, components, apparatuses, steps, and the like may be employed. In other cases, well-known methods, apparatuses, implementations, or operations may not be not shown or described in detail to avoid obscuring various aspects of the present disclosure.

The block diagrams shown in the drawings are merely functional entities, and may, but do not necessarily, correspond to physically independent entities. These functional entities can be implemented in a software form, or in one or more hardware modules or integrated circuits, or in different networks and/or processor apparatuses and/or microcontroller apparatuses.

The flowcharts shown in the drawings are merely exemplary illustrations, do not necessarily include all content and operations/steps, and also do not have to be executed in the described order. For example, some operations/steps may be decomposed, while some operations/steps may be merged or partially merged, so the actual execution order may vary according to actual situations.

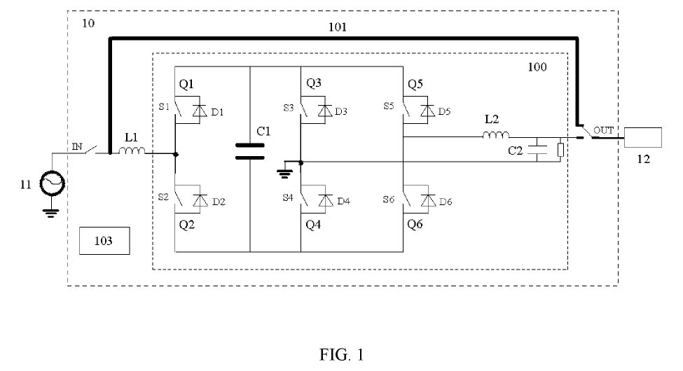

FIG. 1 illustrates a schematic diagram of a circuit structure of an uninterruptible power supply according to an embodiment of the present disclosure. As shown in FIG. 1, UPS 10 is an uninterruptible power supply with a three-bridge arm circuit. Generally, the three-bridge arm circuit includes a rectifier bridge arm, a common bridge arm, and an inverter bridge arm. Under normal power supply by an alternating current input power supply (such as utility power), the UPS 10 employs high-frequency (such as 60 to 100 kHz) pulse width modulation signals to control semiconductor switching devices in two switching modules on the rectifier bridge arm respectively, power frequency (such as 50Hz) complementary pulse width modulation signals to control semiconductor switching devices in two switching modules on the middle common bridge arm respectively, and two high-frequency complementary pulse width modulation signals to control semiconductor switching devices in two switching modules on the inverter bridge arm respectively, thereby converting an alternating current input by the utility power into a direct current and then inverting the direct current back into an alternating current to supply a load.

However, an output frequency of the alternating current input power supply often fluctuates due to various interference factors (such as transmission line faults and load changes). These fluctuations may cause a reverse occurring between an input alternating current voltage and an output alternating current voltage of the uninterruptible power supply. Herein, "reverse" refers to the polarity reversal between the input alternating current voltage and the output alternating current voltage of the uninterruptible power supply, which includes two cases: the input alternating current voltage is greater than zero and the output alternating current voltage is less than zero; and the input alternating current voltage is less than zero and the output alternating current voltage is greater than zero. In these cases, if the power frequency complementary pulse width modulation signals continue to be employed to control the semiconductor switching devices in the two switching modules on the middle common bridge arm respectively, a current in a rectifier side inductor (also known as an input inductor) L1 continues to increase in a single direction, leading to adverse consequences. Specifically, for example, when both the input alternating current voltage and the output alternating current voltage are greater than 0, the semiconductor switching devices in the two switching modules Q1 and Q2 on the rectifier bridge arm are turned on or off at high frequencies, while the semiconductor switching device in the switching module Q4 on the low-side of the common bridge arm is kept on continuously (for example, for 10 ms). At this point, if the input alternating current voltage of UPS 10 is suddenly less than 0 due to sudden jump of the output frequency of the utility power, the input alternating current voltage reversed to the output alternating current voltage continues to charge the input inductor L1 through the semiconductor switching device in the switching module Q4 and a diode in the switching module Q2, so that the current in the input inductor L1 continuously increases in the single direction, thereby damaging a rectifier device.

Therefore, when a reverse occurs between the input alternating current voltage and output alternating current voltage of the uninterruptible power supply, in order to avoid adverse effects such as damage to the rectifier devices caused by the current that continuously increases in a single direction, an existing UPS control method implements reverse control on the three-bridge arm circuit. The reverse control accurately controls on and off time of high-side semiconductor switching devices and low-side semiconductor switching devices on various bridge arms in the three-bridge arm circuit, thereby suppressing continuous increase of the reverse current in a rectifier loop, ensuring stable operation of the circuit, and maintaining the stability of the bus voltage.

However, in practical applications, the frequency of the alternating current input power supply may fluctuate frequently, leading to frequent reverse control on the uninterruptible power supply. After long-term practice and in-depth research, the inventors have found that not every reverse leads to a reverse high inrush current that immediately causes severe adverse consequences. On the contrary, indiscriminate and blind response to every reverse will instead cause the uninterruptible power supply to frequently interrupt its normal operation and switch to the reverse control mode. This unnecessary frequent intervention not only significantly increases the switching losses and noise levels of the uninterruptible power supply, but also negatively impacts on work efficiency, and may even lead to device malfunction in extreme cases.

To overcome the limitations of the aforementioned uninterruptible power supply with the three-bridge arm circuit, the present disclosure provides an improved uninterruptible power supply and a control method thereof.

As shown in FIG. 1, an uninterruptible power supply UPS 10 includes an input terminal IN, an output terminal OUT, an input inductor L1, a three-bridge arm circuit 100, and a controller 103. Wherein, the input terminal IN is electrically connected to an alternating current power supply 11 (such as utility power), the output terminal OUT is electrically connected to a load 12, the three-bridge arm circuit 100 is electrically connected between the input terminal IN and the output terminal OUT, and the input inductor L1 is electrically connected between the input terminal IN and the three-bridge arm circuit 100.

The three-bridge arm circuit 100 is configured to provide rectified and inverted outputs from the input terminal IN to the output terminal OUT to provide electrical energy to the load 12. The three-bridge arm circuit 100 may include a rectifier bridge arm with a high-side first switching module Q1 and a low-side second switching module Q2, a common bridge arm with a high-side third switching module Q3 and a low-side fourth switching module Q4, and an inverter bridge arm with a high-side fifth switching module Q5 and a low-side sixth switching module Q6. In addition, the three-bridge arm circuit 100 may further include a bus capacitor C1, an inverter side inductor L2, and a filter capacitor C2.

In an embodiment of the present disclosure, the rectifier bridge arm is configured to convert an alternating current provided by the alternating current power supply 11 into a direct current, the common bridge arm is configured to regulate and control power transmission, and the inverter bridge arm is configured to invert the direct current into an alternating current to supply the load 12. The controller 103 is configured to control the UPS 10. Specifically, the controller 103 is configured to: compare a first alternating current voltage Uin received at the input terminal IN with a second alternating current voltage Uout output at the output terminal OUT; compare the first alternating current voltage Uin with a first voltage threshold when a reverse occurs between the first alternating current voltage Uin and the second alternating current voltage Uout, where the reverse includes that the first alternating current voltage Uin is greater than zero and the second alternating current voltage Uout is less than zero, or the first alternating current voltage Uin is less than zero and the second alternating current voltage Uout is greater than zero; and execute a reverse control logic on the three-bridge arm circuit 100 when the first alternating current voltage Uin is greater than the first voltage threshold.

In some embodiments of the present disclosure, the controller 103 is further configured to exit the execution of the reverse control logic when the first alternating current voltage Uin and the second alternating current voltage Uout recover to be either both positive or both negative, or when the reverse control logic has been continuously executed for a specified time (such as 10 ms).

In some embodiments of the present disclosure, each of the switching modules Q1 to Q6 may include a controllable switch and a diode connected in anti-parallel with the controllable switch. For example, the first switching module Q1 includes a first controllable switch S1 and a first diode D1, and so on.

In some embodiments of the present disclosure, the controllable switches included in the switching modules Q1 to Q6 may be semiconductor switching devices, such as MOSFETs and IGBTs.

In an embodiment of the present disclosure, the UPS 10 further includes a bypass branch 101 from the input terminal IN to the output terminal OUT.

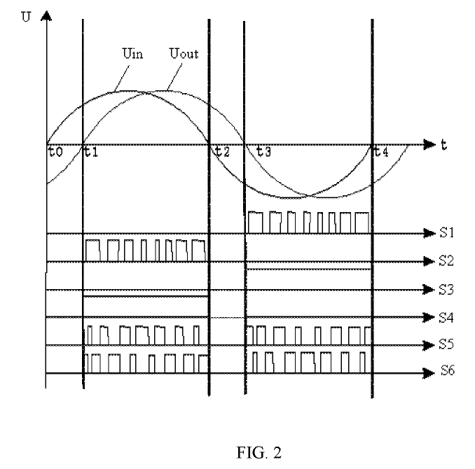

FIG. 2 illustrates a control waveform diagram of multiple controllable switches of an uninterruptible power supply according to an embodiment of the present disclosure. The UPS 10 is in operation. As shown in FIG. 2, at time t1-t2, the first alternating current voltage Uin is in a positive half cycle, and the controller 103 controls the first controllable switch S1 in the first switching module Q1 to remain off, and employs a high-frequency pulse width modulation signal to control the second controllable switch S2 in the second switching module Q2 to turn on/off; meanwhile, the controller 103 controls the third controllable switch S3 in the third switching module Q3 to remain off and controls the fourth controllable switch S4 in the fourth switching module Q4 to remain on; and the controller 103 employs two high-frequency complementary pulse width modulation signals to control on/off of the fifth controllable switch S5 in the fifth switching module Q5 and the sixth controllable switch S6 in the sixth switching module Q6 respectively. When the second controllable switch S2 is controlled to turn on, a current output by the alternating current power supply 11 flows from the input terminal IN through the input inductor L1 into the three-bridge arm circuit 100, and then flows into the fourth controllable switch S4 through the second controllable switch S2 to form a loop, to charge the input inductor L1. When the second controllable switch S2 is controlled to turn off, the input inductor L1 is discharged, and the discharge current flows into the bus capacitor C1 through the first diode D1, and then enters the fourth controllable switch S4 to form a loop, to charge the bus capacitor C1. Meanwhile, the fifth controllable switch S5 and the sixth controllable switch S6 are alternately turned on to invert a direct current provided by the bus capacitor C1 into an alternating current and output the alternating current to the load 12. At time t1-t2, both the first alternating current voltage Uin and the second alternating current voltage Uout are in the positive half cycle.

As shown in FIG. 2, at time t3-t4, the first alternating current voltage Uin is in a negative half cycle, and the controller 103 employs a high-frequency pulse width modulation signal to control the first controllable switch S1 to turn on/off, and controls the second controllable switch S2 in the second switching module Q2 to remain off; meanwhile, the controller 103 controls the third controllable switch S3 in the third switching module Q3 to remain on and controls the fourth controllable switch S4 in the fourth switching module Q4 to remain off; and the controller 103 employs two high-frequency complementary pulse width modulation signals to control on/off of the fifth controllable switch S5 in the fifth switching module Q5 and the sixth controllable switch S6 in the sixth switching module Q6 respectively. When the first controllable switch S1 is controlled to turn on, the current output by the alternating current power supply 11 flows from the input terminal IN through the input inductor L1 into the three-bridge arm circuit 100, and then flows into the third controllable switch S3 through the first controllable switch S1 to form a loop, to charge the input inductor L1. When the first controllable switch S1 is controlled to turn off, the input inductor L1 is discharged, and the discharge current flows into the bus capacitor C1 through the second diode D2, and then enters the third controllable switch S3 to form a loop, to charge the bus capacitor C1. Meanwhile, the fifth controllable switch S5 and the sixth controllable switch S6 are alternately turned on to invert a direct current provided by the bus capacitor C1 into an alternating current and output the alternating current to the load 12. At time t3-t4, both the first alternating current voltage Uin and the second alternating current voltage Uout are in the negative half cycle.

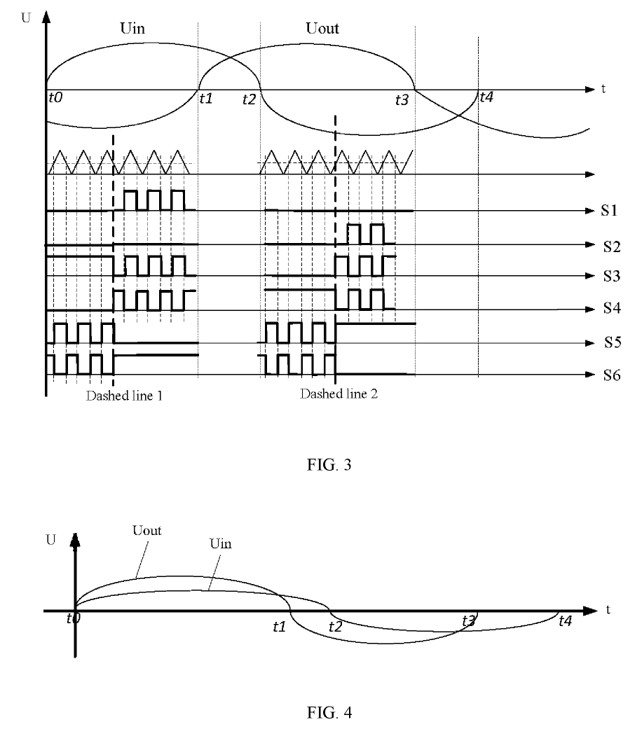

FIG. 3 illustrates a control waveform diagram of multiple controllable switches of an uninterruptible power supply according to another embodiment of the present disclosure. The UPS 10 is in operation, and the controller 103 compares the first alternating current voltage Uin received at the input terminal IN with the second alternating current voltage Uout output at the output terminal OUT. As shown in FIG. 3, at time t0, due to frequency fluctuations of the alternating current input power supply, the first alternating current voltage Uin jumps from a negative voltage to a positive voltage, while the second alternating current voltage Uout is a negative voltage. The controller 103 determines that a reverse occurs between the first alternating current voltage Uin and the second alternating current voltage Uout since time t0. Then, the controller 103 compares the first alternating current voltage Uin with the first voltage threshold Uth. When the first alternating current voltage Uin is not greater than the first voltage threshold Uth, the controller 103 does not execute the reverse control logic on the three-bridge arm circuit 100. As shown in FIG. 3, at a time corresponding to a dashed line 1, the first alternating current voltage Uin is greater than the first voltage threshold Uth, and the controller 103 executes the reverse control logic on the three-bridge arm circuit 100. At time t1, the second alternating current voltage Uout becomes a positive voltage, and the controller 103 exits the execution of the reverse control logic.

As shown in FIG. 3, at time t2, the first alternating current voltage Uin jumps from a positive voltage to a negative voltage, while the second alternating current voltage Uout is a positive voltage. The controller 103 determines that a reverse occurs between the first alternating current voltage Uin and the second alternating current voltage Uout since time t2. Then, the controller 103 compares the first alternating current voltage Uin with the first voltage threshold Uth. When the first alternating current voltage Uin is not greater than the first voltage threshold Uth, the controller 103 does not execute the reverse control logic on the three-bridge arm circuit 100. As shown in FIG. 3, at a time corresponding to a dashed line 2, the first alternating current voltage Uin is greater than the first voltage threshold Uth, and the controller 103 executes the reverse control logic. At time t3, the second alternating current voltage Uout becomes a negative voltage, and the controller 103 exits the execution of the reverse control logic.

In some embodiments of the present disclosure, during the period when the reverse occurs between the first alternating current voltage Uin and the second alternating current voltage Uout and the first alternating current voltage Uin does not exceed the first voltage threshold Uth, the controller 103 may further be configured to control the first controllable switch S1 and the second controllable switch S2 to turn off, while keeping original control logics for other switching modules unchanged, so as to alleviate adverse effects caused by reverse events.

In some embodiments of the present disclosure, the alternating current power supply 11 is utility power, and the first voltage threshold Uth is determined based on an effective value of the first alternating current voltage Uin. The inventors of the present disclosure have verified in long-term practice that the first voltage threshold Uth is 5% to 10% of the effective value of the first alternating current voltage Uin, preferably 10 V, 12 V, or 15 V.

By appropriately setting the first voltage threshold Uth, the embodiments of the present disclosure can not only ensure within a limited time that reverse events may cause some temporary adverse effects but will not disrupt the normal operation of the UPS 10, but also can make responses and interventions immediately when the reverse events satisfy threshold conditions, thereby ensuring stability and continuity of the system. The optimized uninterruptible power supply can effectively avoid excessive responses to the reverse events, and prevent the interruption of normal operation of the UPS 10 by intervention mechanisms triggered due to false or short-term reverse events. Through such optimized threshold setting, the present disclosure improves the tolerance of the system to the reverse events, while also enhancing the overall reliability and operational efficiency of the system.

According to some embodiments of the present disclosure, the reverse control logic is configured to control multiple controllable switches included in the three-bridge arm circuit 100, so as to avoid continuous charging of the input inductor L1 of the uninterruptible power supply UPS 10 during a reverse occurring between the first alternating current voltage Uin and the second alternating current voltage Uout, thereby suppressing the reverse inrush current in the rectifier loop from damaging the switching devices, and ensuring the stability of the second alternating current voltage Uout.

According to some embodiments of the present disclosure, the reverse control logic may be configured to: control the first controllable switch S1 in the first switching module Q1 and the second controllable switch S2 in the second switching module Q2 to turn off; meanwhile, send a first pulse width modulation signal and a second pulse width modulation signal with a first frequency to a control terminal of the third controllable switch S3 in the third switching module Q3 and a control terminal of the fourth controllable switch S4 in the fourth switching module Q4, respectively, where the first pulse width modulation signal and the second pulse width modulation signal are complementary and the first frequency is greater than a frequency of the alternating current power supply 11; when the second alternating current voltage Uout is greater than zero, control the fifth controllable switch S5 in the fifth switching module Q5 to turn on and control the sixth controllable switch S6 in the sixth switching module Q6 to turn off; and when the second alternating current voltage Uout is less than zero, control the fifth controllable switch S5 in the fifth switching module Q5 to turn off and control the sixth controllable switch S6 in the sixth switching module Q6 to turn on.

According to some embodiments of the present disclosure, the reverse control logic may further be configured to: when the first alternating current voltage Uin is greater than zero, send a third pulse width modulation signal with a second frequency to a control terminal of the first controllable switch S1 in the first switching module Q1, and control the second controllable switch S2 in the second switching module Q2 to turn off; when the first alternating current voltage is less than zero, control the first controllable switch S1 in the first switching module Q1 to turn off and output a fourth pulse width modulation signal with the second frequency to a control terminal of the second controllable switch S2 in the second switching module Q2, where the second frequency is greater than the frequency of the alternating current power supply 11; meanwhile, output the third pulse width modulation signal and the fourth pulse width modulation signal to the control terminal of the third controllable switch S3 in the third switching module Q3 and the control terminal of the fourth controllable switch S4 in the fourth switching module Q4, respectively, where the third pulse width modulation signal and the fourth pulse width modulation signal are complementary; when the second alternating current voltage Uout is greater than zero, control the fifth controllable switch S5 in the fifth switching module Q5 to turn on and control the sixth controllable switch S6 in the sixth switching module Q6 to turn off; and when the second alternating current voltage Uout is less than zero, control the fifth controllable switch S5 in the fifth switching module Q5 to turn off and control the sixth controllable switch S6 in the sixth switching module Q6 to turn on. When the reverse control logic is executed, the UPS 10 can achieve lower switching losses, thereby significantly improving the overall efficiency and reliability of the system.

By introducing a tolerance determination mechanism and optimizing the reverse control logic, the foregoing embodiments of the present disclosure can effectively avoid excessive responses of the UPS 10 to the reverse events, and prevent the interruption of normal operation of the uninterruptible power supply due to the frequent execution of the reverse control logic, thereby significantly enhancing the stability and continuity of the system; and the foregoing embodiments of the present disclosure can also reduce switching losses caused by the execution of the reverse control logic and further improve the operational efficiency of the uninterruptible power supply.

In the uninterruptible power supply with the three-bridge arm circuit, the common bridge arm and the inverter bridge arm in the three-bridge arm circuit form an inverter to achieve direct current to alternating current conversion. Generally, in order to improve the efficiency of the inverter, unipolar control is employed for inverter H4 bridges, that is, the common bridge arm serves as a power frequency bridge arm, and the inverter bridge arm serves as a high-frequency bridge arm. Furthermore, the power frequency bridge arm of the inverter is prone to waveform distortion, oscillation, or voltage jump near a zero-crossing point. These problems negatively impact the normal operation of a load device. Therefore, the controller 103 will perform high-frequency control on a zero point of the power frequency bridge arm, to suppress the distortion and oscillation at the zero-crossing point, making an output waveform of the inverter smoother and more stable. Therefore, during the operation of the uninterruptible power supply, an initial time of occurrence of a reverse event may coincide with a time when the inverter enters the zero-crossing point. FIG. 4 illustrates a waveform diagram of an input alternating current voltage and an output alternating current voltage of an uninterruptible power supply according to an embodiment of the present disclosure when an inverter just enters a zero-crossing point at an initial time of occurrence of a reverse event. As shown in FIG. 4, at an initial time of a reverse event, namely, time t1, the inverter just enters the zero-crossing point (the second alternating current voltage Uout passes through the zero-crossing point). Therefore, aspects of the present disclosure further optimize the uninterruptible power supply and the controller thereof to avoid conflicts occurring between the reverse control logic and the high-frequency control at the zero-crossing point.

Because the controller 103 interrupts the high-frequency control on the inverter but executes the reverse control logic, the operational state of the uninterruptible power supply may be further deteriorated to cause a series of problems, such as distortion of the output alternating current voltage. In addition, the high-frequency control performed by the controller 103 on the inverter at the zero-crossing point can alleviate adverse effects caused by reverse events, such as reduce the charging speed of the input inductor L1. Therefore, the controller 103 may be configured to: determine whether the second alternating current voltage Uout passes through the zero-crossing point at a reverse starting time when a reverse occurs between the first alternating current voltage Uin and the second alternating current voltage Uout (an initial time of a reverse event); if the second alternating current voltage Uout passes through the zero-crossing point at the reverse starting time, when the first alternating current voltage Uin is greater than the first voltage threshold Uth, compare a phase of the second alternating current voltage Uout with a first phase threshold Rth1; and when the phase of the second alternating current voltage Uout is greater than the first phase threshold Rth1, execute the reverse control logic. The controller 103 performs zero-crossing high-frequency control on the inverter between 0 degrees and the first phase threshold Rth1. In addition, the first alternating current voltage Uin may exhibit waveform characteristics similar to square waves. Rising edges and falling edges of such waveforms are extremely steep, with voltage values rising rapidly in an extremely short time. In this case, once a reverse occurs, if the determination criterion of whether the uninterruptible power supply executes the reverse control logic relies solely on whether the first alternating current voltage Uin is greater than the first voltage threshold Uth, such waveforms would frequently trigger the execution of the reverse control logic, thereby severely impacting the normal operation of the uninterruptible power supply. The present disclosure can effectively avoid the occurrence of the above situation by further optimizing the uninterruptible power supply and adding the determination condition for the phase of the second alternating current voltage Uout. This improvement measure can significantly improve the operational stability and efficiency of the uninterruptible power supply and ensure that the uninterruptible power supply can still operate reliably even under complex working conditions.

In at least one embodiment of the present disclosure, the zero-crossing high-frequency control on the inverter is specifically implemented as follows: by employing an adaptive variable frequency modulation strategy, the switching frequency of the semiconductor switching device is increased to a preset high-frequency value (such as 80 kHz) between the zero-crossing point and the first phase threshold Rth1, so as to improve the waveform quality at the zero-crossing point, reduce oscillation and distortion, and enhance the quality of electrical energy output by the inverter. According to some embodiments of the present disclosure, the first phase threshold Rth1 is between 8 degrees and 10 degrees. In a preferred aspect, the first phase threshold Rth1 is 9 degrees.

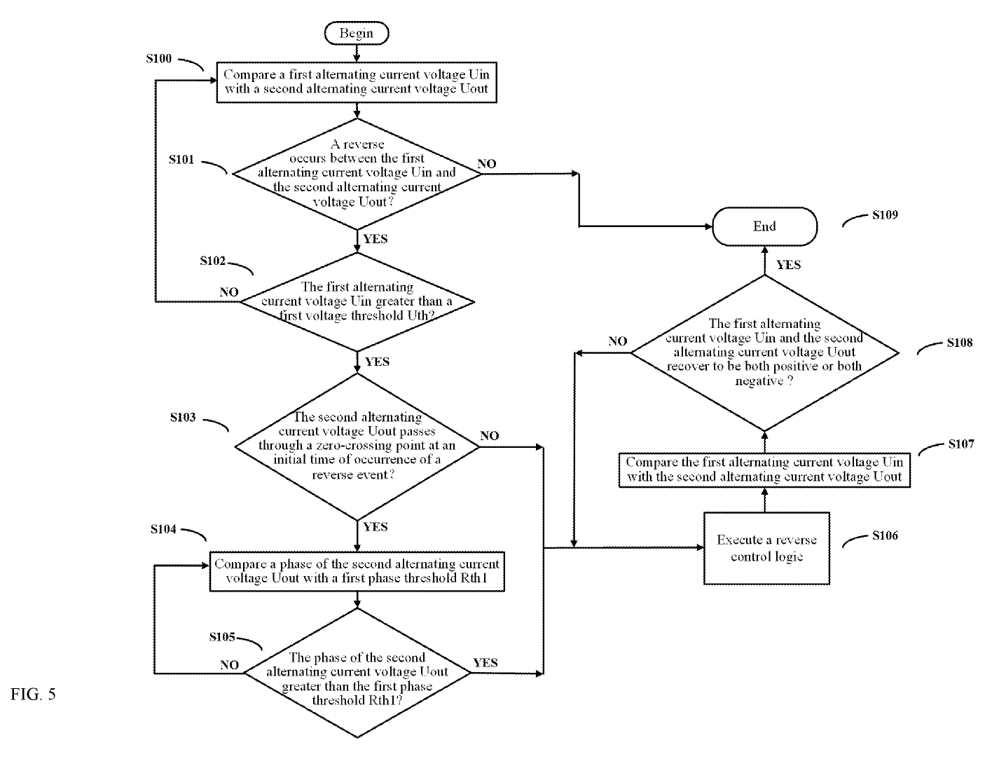

An embodiment of the present disclosure further provides a control method for an uninterruptible power supply, where the uninterruptible power supply has a three-bridge arm circuit 100. As shown in FIG. 5, the control method includes the following steps:

S100: Compare a first alternating current voltage Uin with a second alternating current voltage Uout.

S101: Determine whether a reverse occurs between the first alternating current voltage Uin and the second alternating current voltage Uout. If a reverse occurs between the first alternating current voltage Uin and the second alternating current voltage Uout, step S102 is performed. Otherwise, if there is no reverse occurring between the first alternating current voltage Uin and the second alternating current voltage Uout, step S109 is performed. Wherein, the reverse includes that the first alternating current voltage Uin is greater than zero and the second alternating current voltage Uout is less than zero, or the first alternating current voltage Uin is less than zero and the second alternating current voltage Uout is greater than zero.

S102: Determine whether the first alternating current voltage Uin is greater than a first voltage threshold Uth. If the first alternating current voltage Uin is greater than the first voltage threshold Uth, step S103 is performed. Otherwise, if the first alternating current voltage Uin is not greater than the first voltage threshold Uth, step S100 is performed. That is, when the first alternating current voltage Uin is not greater than the first voltage threshold, the uninterruptible power supply does not respond to the foregoing reverse event; and when the first alternating current voltage Uin is greater than the first voltage threshold Uth, the uninterruptible power supply performs the next step.

S103: Determine whether the second alternating current voltage Uout passes through a zero-crossing point at an initial time of occurrence of a reverse event. If the second alternating current voltage Uout passes through the zero-crossing point at the initial time of occurrence of the reverse event, step S104 is performed. Otherwise, if the second alternating current voltage Uout does not pass through the zero-crossing point at the initial time of occurrence of the reverse event, step S106 is performed. Step S103 is used to determine whether the inverter in the uninterruptible power supply is being subjected to high-frequency control due to just entering the zero-crossing point at the initial time of occurrence of the reverse event.

S104: Compare a phase of the second alternating current voltage Uout with a first phase threshold Rth1. The first phase threshold Rth1 may be determined based on actual working conditions.

S105: Determine whether the phase of the second alternating current voltage Uout is greater than the first phase threshold Rth1. If the phase of the second alternating current voltage Uout is greater than the first phase threshold Rth1, step S106 is performed. Otherwise, if the phase of the second alternating current voltage Uout is not greater than the first phase threshold Rth1, step S104 is performed.

S106: Execute a reverse control logic.

S107: Compare the first alternating current voltage Uin with the second alternating current voltage Uout.

S108: Determine whether the first alternating current voltage Uin and the second alternating current voltage Uout recover to be either both positive or both negative. If the first alternating current voltage Uin and the second alternating current voltage Uout recover to be either both positive or both negative, step S109 is performed. Otherwise, if the first alternating current voltage Uin and the second alternating current voltage Uout do not recover to be either both positive or both negative, step S106 is performed.

S109: End.

In the embodiments of the present disclosure, any combination or sequence adjustment of the foregoing steps can be performed according to actual needs. For example, when the determination result in step S102 is "yes", steps S103 to S105 can be omitted and step S106 can be directly performed, that is, the reverse control logic is executed.

According to the embodiments of the present disclosure, accurate response to reverse events is achieved by optimizing the uninterruptible power supply and the controller thereof and introducing the tolerance determination mechanism. The optimized uninterruptible power supply activates a response mechanism to enter reverse control only when a reverse event exceeds strictly set threshold conditions, thereby effectively avoiding excessive response to minor or instantaneous reverse events. This innovative design significantly reduces unnecessary reverse control interventions, significantly reduces switching losses and noise, and effectively extends the service life of a device. Meanwhile, this design further significantly enhances the adaptability and reliability of the uninterruptible power supply under complex power grid conditions, and enables the uninterruptible power supply to operate stably under various harsh working conditions, providing strong guarantees for the safe and reliable operation of a power system.

In the present disclosure, the input alternating current voltage, the first alternating current voltage, the output alternating current voltage, or the second alternating current voltage of the uninterruptible power supply all refer to an effective value of an alternating current voltage. The phase of the output alternating current voltage and the phase of the second alternating current voltage Uout of the uninterruptible power supply refer to phase values. For example, an actual phase of the second alternating current voltage Uout is -15 degrees, indicating a phase value of 15 degrees.

The reference to "various embodiments", "some embodiments", "one embodiment", "embodiments", or the like in the specification means that specific features, structures, or properties described with reference to the embodiments are included in at least one embodiment. Therefore, the phrase "in various embodiments", "in some embodiments", "in one embodiment", "in embodiments", or the like does not necessarily refer to the same embodiment throughout the specification. In addition, the specific features, structures, or properties may be combined in any suitable manner in one or more embodiments. Therefore, the specific features, structures, or properties shown or described with reference to one embodiment may be combined, in whole or in part without limitation, with the features, structures, or properties of one or more other embodiments, provided that the combination is not non-logical or inoperable.

The terms "include" and "have" as well as term expressions with a similar meaning in the specification are intended to cover a non-exclusive inclusion, for example, a process, a method, a system, a product, or a device that includes a series of steps or units is not limited to the listed steps or units, but optionally further includes an unlisted step or unit, or optionally further includes another step or unit inherent to the process, the method, the product, or the device. In addition, the various elements in the accompanying drawings of the present disclosure are merely used for schematic description, and are not drawn in a scale.

Although the present disclosure has been described by using preferred embodiments, the present disclosure is not limited to the embodiments described herein, and includes various changes and variations without departing from the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An uninterruptible power supply, comprising:
an input terminal, configured to be electrically connectable to an alternating current power supply;
an output terminal, configured to be electrically connectable to a load;
a three-bridge arm circuit electrically connected between the input terminal and the output terminal, and configured to provide rectified and inverted outputs from the input terminal to the output terminal; and
a controller, wherein the controller is configured to:
compare a first alternating current voltage received at the input terminal with a second alternating current voltage output at the output terminal;
compare the first alternating current voltage with a first voltage threshold when a reverse occurs between the first alternating current voltage and the second alternating current voltage, wherein the reverse comprises that either the first alternating current voltage is greater than zero and the second alternating current voltage is less than zero, or the first alternating current voltage is less than zero and the second alternating current voltage is greater than zero; and
execute a reverse control logic on the three-bridge arm circuit when the first alternating current voltage is greater than the first voltage threshold.

2. The uninterruptible power supply according to claim 1, wherein the controller is further configured to:
determine a reverse starting time when the reverse occurs between the first alternating current voltage and the second alternating current voltage;
determine that the second alternating current voltage passes through a zero-crossing point at the reverse starting time; and
based on the second alternating current voltage passing through the zero-crossing point at the reverse starting time, execute the reverse control logic on the three-bridge arm circuit when the first alternating current voltage is greater than the first voltage threshold and a phase of the second alternating current voltage is greater than a first phase threshold.

3. The uninterruptible power supply according to claim 1, wherein the reverse control logic is deactivated when the first alternating current voltage and the second alternating current voltage recover to be either both positive or both negative.

4. The uninterruptible power supply according to claim 1, wherein the three-bridge arm circuit comprises a rectifier bridge arm, a common bridge arm, and an inverter bridge arm; the rectifier bridge arm has a high-side first switching module and a low-side second switching module; the common bridge arm has a high-side third switching module and a low-side fourth switching module; and the inverter bridge arm has a high-side fifth switching module and a low-side sixth switching module.

5. The uninterruptible power supply according to claim 4, wherein the reverse control logic comprises:
controlling a controllable switch in the first switching module and a controllable switch in the second switching module to turn off;
meanwhile, sending a first pulse width modulation signal and a second pulse width modulation signal with a first frequency to a control terminal of a controllable switch in the third switching module and a control terminal of a controllable switch in the fourth switching module respectively, wherein the first pulse width modulation signal and the second pulse width modulation signal are complementary and the first frequency is greater than a frequency of the alternating current power supply; and
when the second alternating current voltage is greater than zero, controlling a controllable switch in the fifth switching module to turn on and controlling a controllable switch in the sixth switching module to turn off; when the second alternating current voltage is less than zero, controlling the controllable switch in the fifth switching module to turn off and controlling the controllable switch in the sixth switching module to turn on.

6. The uninterruptible power supply according to claim 4, wherein the reverse control logic comprises:
when the first alternating current voltage is greater than zero, sending a third pulse width modulation signal with a second frequency to a control terminal of the controllable switch in the first switching module, and controlling a controllable switch in the second switching module to turn off;
when the first alternating current voltage is less than zero, controlling the controllable switch in the first switching module to turn off and outputting a fourth pulse width modulation signal with the second frequency to a control terminal of the controllable switch in the second switching module, wherein the second frequency is greater than the frequency of the alternating current power supply;
meanwhile, outputting the third pulse width modulation signal and the fourth pulse width modulation signal to a control terminal of a controllable switch in the third switching module and a control terminal of a controllable switch in the fourth switching module respectively, wherein the third pulse width modulation signal and the fourth pulse width modulation signal are complementary; and
when the second alternating current voltage is greater than zero, controlling a controllable switch in the fifth switching module to turn on and controlling a controllable switch in the sixth switching module to turn off; when the second alternating current voltage is less than zero, controlling the controllable switch in the fifth switching module to turn off and controlling the controllable switch in the sixth switching module to turn on.

7. The uninterruptible power supply according to claim 1, wherein the alternating current power supply is utility power, and the first voltage threshold is determined based on an effective value of the first alternating current voltage.

8. The uninterruptible power supply according to claim 2, wherein the first phase threshold is between 8 degrees and 10 degrees.

9. A control method for an uninterruptible power supply, the uninterruptible power supply comprising a three-bridge arm circuit, the method comprising:
comparing a first alternating current voltage received at an input terminal of the uninterruptible power supply with a second alternating current voltage output at an output terminal of the uninterruptible power supply;
comparing the first alternating current voltage with a first voltage threshold when a reverse occurs between the first alternating current voltage and the second alternating current voltage, wherein the reverse comprises that either the first alternating current voltage is greater than zero and the second alternating current voltage is less than zero, or the first alternating current voltage is less than zero and the second alternating current voltage is greater than zero; and
executing a reverse control logic on the three-bridge arm circuit when the first alternating current voltage is greater than the first voltage threshold.

10. The control method according to claim 9, further comprising:
determining a reverse starting time when the reverse occurs between the first alternating current voltage and the second alternating current voltage;
determining that the second alternating current voltage passes through a zero-crossing point at the reverse starting time; and
based on the second alternating current voltage passing through the zero-crossing point at the reverse starting time, executing the reverse control logic on the three-bridge arm circuit when the first alternating current voltage is greater than the first voltage threshold and a phase of the second alternating current voltage is greater than a first phase threshold.
